(19) United States
(12) Patent Application Publication
(10) Pub. No.: US 2019/0257269 A1
(43) Pub. Date: Aug. 22, 2019

(54) TURBOJET ENGINE COMPRISING A NACELLE EQUIPPED WITH A THRUST-REVERSING SYSTEM COMPRISING OUTER AND INNER DOORS

(71) Applicants: Airbus Operations (S.A.S.), Toulose (FR); Airbus (S.A.S.), Blagnac (FR)

(72) Inventors: Eric Rambaud, Les Sorinieres (FR); Denis Brossard, Saint Aignan de Grand Lieu (FR); Frédéric Ridray, L'isle Jourdain (FR); Philippe Descamps, Reze (FR); Xavier Bardey, Pibrac (FR); Stéphane Le Clainche, Cheix En Retz (FR)

(73) Assignees: Airbus Operations (S.A.S.), Toulouse (FR); Airbus (S.A.S.), Blagnac (FR); Airbus (S.A.S.), Blagnac (FR)

(21) Appl. No.: 16/280,593

(22) Filed: Feb. 20, 2019

(30) Foreign Application Priority Data
Feb. 22, 2018 (FR) 1851556

(51) Int. Cl. F02K 1/76; B64D 29/06; B64D 31/02; F02K 1/62; F16H 21/44

(52) U.S. Cl. CPC F02K 1/763; B64D 29/06; F16H 21/44; F02K 1/62; B64D 31/02

(57) ABSTRACT

A turbojet engine including an engine, a fan casing and a nacelle including a fixed structure and a thrust-reversing system having a mobile assembly with a mobile cowl and a frame, in which the mobile assembly is translationally mobile on the fixed structure between an advanced position and a retracted position to define a window between the secondary jet and the outside of the nacelle, inner doors and outer doors, a runner translationally mobile between a first position and a second position, in which each door is mounted articulated by a rear edge on the runner between a stowed position and a deployed position, an actuator for ensuring the translational displacement of the runner from the first position to the second position and an actuator for ensuring the displacement of the frame from the advanced position to the retracted position.

### CROSS-REFERENCE TO RELATED APPLICATION

This application claims priority to French Patent Application 18 51556 filed on Feb. 22, 2018, the entire disclosure of which is incorporated by reference herein.

### TECHNICAL FIELD

The disclosure herein relates to a dual-flow turbojet engine which comprises a nacelle equipped with a thrust-reversing system comprising outer and inner doors, and an aircraft comprising at least one such dual-flow turbojet engine.

### BACKGROUND

An aircraft comprises a fuselage on each side of which is fixed a wing. Under each wing there is suspended at least one dual-flow turbojet engine with a secondary jet. Each dual-flow turbojet engine is fixed under the wing via a pylon which is fixed between the structure of the wing and the structure of the dual-flow turbojet engine.

The dual-flow turbojet engine comprises an engine and a nacelle which is fixed around the engine to delimit or define, between them, a secondary jet.

The nacelle comprises a thrust-reversing system which comprises a plurality of inner doors, in which each is mobile between a stowed position in which it is pressed against an inner surface of the nacelle around the secondary jet, and a deployed position in which it is positioned across the secondary jet to direct the secondary flow to a window cleared in the nacelle by the displacement of the inner door.

It is advantageous to be able to find a thrust-reversing system which is optimized and implemented by a simple mechanism.

### SUMMARY

One object of the disclosure herein is a dual-flow turbojet engine which comprises a nacelle equipped with a thrust-reversing system with a plurality of outer and inner doors and with a different opening/closing mechanism.

To this end, a dual-flow turbojet engine is proposed comprising an engine, a nacelle surrounding the engine and a fan casing, in which a secondary jet of a secondary flow is delimited or defined between the nacelle and the engine and in which an air flow circulates according to a direction of flow, the nacelle comprising:
a fixed structure attached to the fan casing,
a thrust-reversing system having:
a mobile assembly having a frame and a mobile cowl fixed to the frame, the mobile assembly being translationally mobile on the fixed structure according to a direction of translation between an advanced position in which the mobile assembly is positioned in such a way that the mobile cowl is close to the fan casing and a retracted position in which the mobile assembly is positioned in such a way that the mobile cowl is away from the fan casing to define, between them, an open window between the secondary jet and the outside of the nacelle,
a plurality of pairs of doors, each pair being formed by an inner door and an outer door arranged facing the inner door,
for each pair of doors, a runner mounted to be translationally mobile parallel to the direction of translation on the frame between a first position and a second position,

in which each door of a pair is mounted articulated by a rear edge on the associated runner, between a stowed position in which it blocks a zone of the window and a deployed position in which it does not block the zone of the window, the inner doors extending towards the engine in deployed position, the outer doors extending towards the outside of the nacelle in deployed position,
for each runner, a first transmission system provided to switch the inner door associated with the runner from the stowed position to the deployed position simultaneously with the switching of the runner from the first position to the second position and vice versa, and a second transmission system provided to switch the outer door associated with the runner from the stowed position to the deployed position simultaneously with the switching of the runner from the first position to the second position and vice versa, and
at least one first actuator provided to ensure the translational displacement of the frame from the advanced position to the retracted position and vice versa, and
for each runner, a second actuator fixed partly to the frame and provided to ensure the translational displacement of the runner from the first position to the second position and vice versa.

Such a turbojet engine makes it possible to optimize the thrust reverser through the placement of inner and outer doors, to simplify the mechanism actuating the thrust-reversing system and to dissociate the displacement of the mobile assembly from the displacement of the outer and inner doors.

Advantageously, the frame comprises two rods arranged across the window and extending parallel to the direction of translation, and, for each rod, the runner has a bore in which the rod is fitted.

Advantageously, the first transmission system comprises at least one first connecting rod articulated by one end on the inner door and articulated by another end on the frame.

Advantageously, the first transmission system comprises two first connecting rods arranged on either side of a median plane of the inner door.

Advantageously, the articulation on the frame is arranged forward relative to the articulation of the first connecting rod on the inner door.

Advantageously, the second transmission system comprises at least one second connecting rod articulated by one end on the outer door and articulated by another end on the frame.

Advantageously, the second transmission system comprises two second connecting rods arranged on either side of a median plane of the outer door.

Advantageously, the articulation on the frame is arranged forward relative to the articulation of the second connecting rod on the outer door.

Advantageously, the outer doors are arranged between the mobile cowl and the fixed structure in stowed position so as to constitute an outer wall of the nacelle.

The disclosure herein also proposes an aircraft comprising at least one dual-flow turbojet engine according to one of the preceding variants.

### BRIEF DESCRIPTION OF THE DRAWINGS

The features of the disclosure herein mentioned above, and others, will emerge more clearly on reading the following description of an example embodiment, the description being given in relation to the attached, example drawings, in which:

FIG. 1 is a side view of an aircraft comprising a dual-flow turbojet engine according to the disclosure herein;

FIG. 2 is a perspective and interior view of a part of a nacelle of the dual-flow turbojet engine according to the disclosure herein;

FIG. 3 is schematic and cross-sectional representation of a thrust-reversing system according to the disclosure herein in advanced and stowed position;

FIG. 4 is a representation similar to that of FIG. 3 for an intermediate position corresponding to a retracted and stowed position;

FIG. 5 is a representation similar to that of FIG. 3 for a retracted and deployed position; and

FIG. 6 shows an outer view of the thrust-reversing system.

### DETAILED DESCRIPTION

In the following description, the terms relating to a position are taken with reference to the direction of advance of the aircraft and the flow of air in the turbojet engine therefore flows from front to rear of the aircraft while the aircraft is displaced forwards.

FIG. 1 shows an aircraft 10 which comprises a fuselage 12, on each side of which is fixed a wing 14 which bears at least one dual-flow turbojet engine 100 according to the disclosure herein. The dual-flow turbojet engine 100 is fixed under the wing 14 via a pylon 16.

The dual-flow turbojet engine 100 has a nacelle 102, an engine which is housed inside the nacelle 102 in the form of a core and a fan casing 206a in front of the nacelle 102.

In the following description, and by convention, X denotes the longitudinal axis of the dual-flow turbojet engine 100 which is parallel to the longitudinal axis of the aircraft 10 oriented positively towards the front of the aircraft 10, Y denotes the transverse axis which is horizontal when the aircraft is on the ground, and Z denotes the vertical axis, these three directions X, Y and Z being mutually orthogonal.

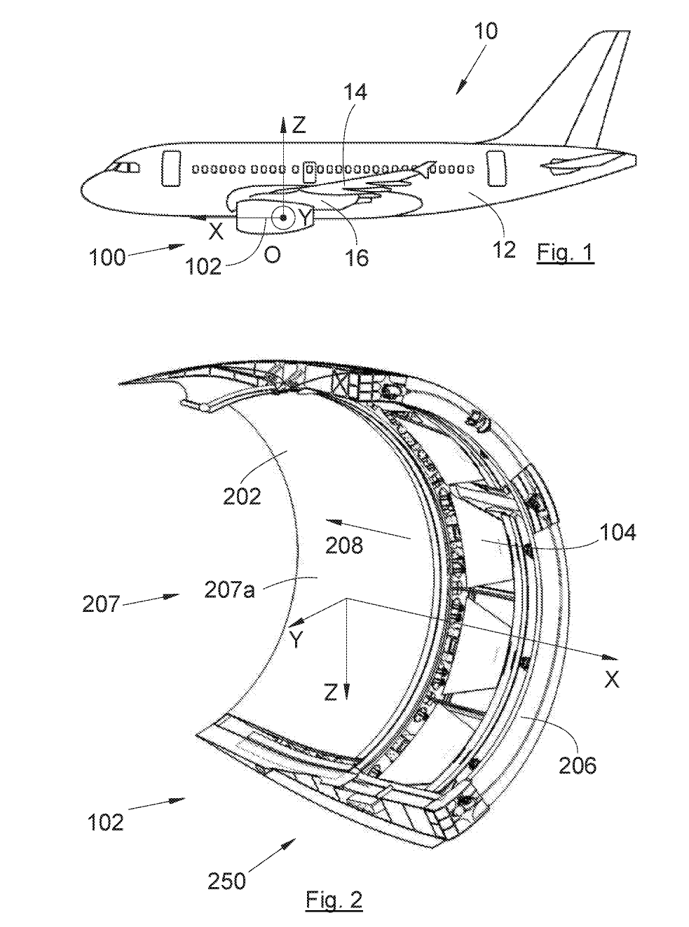

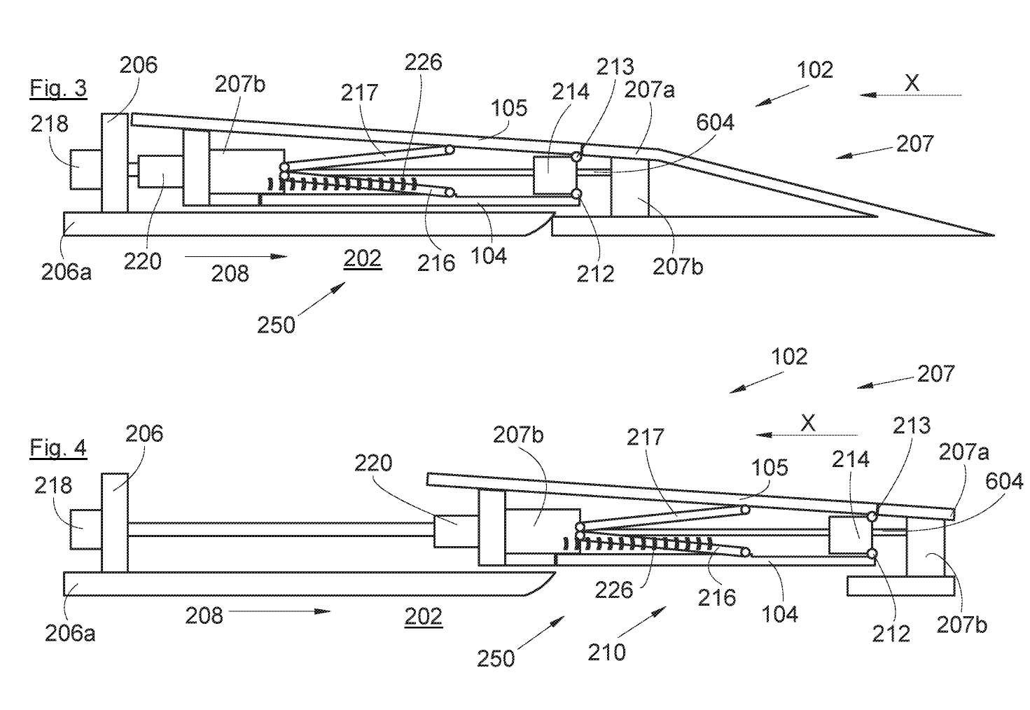

FIG. 2 shows a part of the nacelle 102 and FIGS. 3 through 5 show different positions of a thrust-reversing system 250 of the nacelle 102. FIG. 6 shows an outer view of the thrust-reversing system 250 in retracted and deployed position, but in which only one outer door 105 is schematically represented by chain-dotted lines.

The dual-flow turbojet engine 100 has, between the nacelle 102 and the engine, a secondary jet 202 in which circulates the secondary flow 208 originating from the air inlet through the fan and which therefore flows according to the direction of flow which goes from the front to the rear of the nacelle 102.

The nacelle 102 has a fixed structure 206 which is fixedly mounted on the fan casing 206a.

The thrust-reversing system 250 has a mobile assembly 207 which comprises a mobile cowl 207a forming the walls of the nozzle and a frame 207b. The frame 207b here takes the form of a cylinder with openwork walls. The mobile cowl 207a is fixed to and behind the frame 207b.

The mobile assembly 207, via the frame 207b, is mounted to be translationally mobile according to a direction of translation that is globally parallel to the longitudinal axis X on the fixed structure 206 of the nacelle 102, and, more particularly here, on the 12 o'clock beam and the 6 o'clock beam.

The translation of the frame 207b, and therefore of the mobile assembly 207, is produced by any appropriate guideway system such as, for example, guideways between the fixed structure 206 and the frame 207b.

The mobile assembly 207, and therefore the frame 207b, is mobile between an advanced position (FIG. 3) and a retracted position (FIGS. 4, 5 and 6) and vice versa. In advanced position, the mobile assembly 207, and therefore the frame 207b, is positioned as far forward as possible relative to the longitudinal axis X in such a way that the mobile cowl 207a is close to the fan casing 206a. In retracted position, the mobile assembly 207, and therefore the frame 207b, is positioned as far backward as possible relative to the longitudinal axis X so that the mobile cowl 207a is away from the fan casing 206a towards the rear.

In advanced position, the mobile cowl 207a and the fan casing 206a extend one another so as to define the outer surface of the secondary jet 202.

In retracted position, the mobile cowl 207a and the fan casing 206a are at a distance and define, between them, an open window 210 between the secondary jet 202 and the outside of the nacelle 102. That is to say that the air originating from the secondary flow 208 passes through the window 210 to rejoin the outside of the dual-flow turbojet engine 100.

The fan casing 206a delimits the window 210 at the front relative to the longitudinal axis X and the mobile cowl 207a delimits the window 210 at the rear relative to the longitudinal axis X.

The nacelle 102 comprises a plurality of inner doors 104 distributed over the periphery of and inside the nacelle 102 according to the angular aperture of the window 210 about the longitudinal axis X.

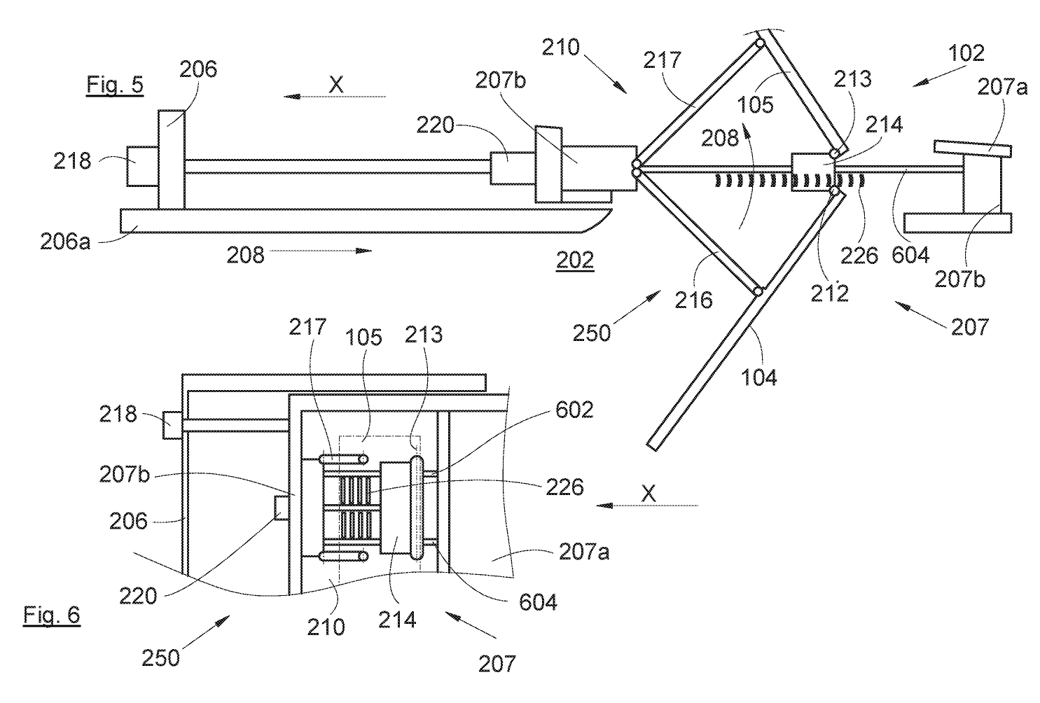

Each inner door 104 is mounted articulated on a runner 214 between a stowed position (FIGS. 3 and 4) and a deployed position (FIG. 5) and vice versa. The switch from the stowed position to the deployed position is performed by a rotation of the inner door 104 towards the interior of the turbojet engine 100. The articulation is performed along a rear edge of the inner door 104 while the front edge of the inner door 104 is displaced.

The stowed position of the inner doors 104 can be adopted when the frame 207b is in advanced position or in retracted position. The deployed position of the inner doors 104 can be adopted only when the frame 207b is in retracted position.

In stowed position, each inner door 104 blocks a zone of the openwork part of the frame 207b when the latter is in advanced position and the same zone of the openwork part of the frame 207b and a zone of the window 210 when the frame 207b is in retracted position. In deployed position, the inner door 104 does not block the zone of the window 210 or the openwork part of the frame 207b allowing the passage of the secondary flow 208 and the inner door 104 extends towards the engine, that is to say across the secondary jet 202.

Thus, in stowed and advanced position, each inner door 104 is positioned outside of the fan casing 206a and in deployed position, each inner door 104 is positioned across the secondary jet 202 and deflects at least a part of the secondary flow 208 towards the outside through the window 210, the flow is oriented towards the front with the help of outer doors 105 making it possible to produce a counter-thrust and which are described herein below.

Each inner door 104 is articulated by its rear edge on the runner 214 on hinges 212 fixed to the runner 214 while the opposite front edge is free and is positioned towards the front in stowed position and towards the engine in deployed position.

The thrust-reversing system 250 also comprises, for each inner door 104, an outer door 105. The outer doors 105 are distributed over the periphery and outside of the nacelle 102 according to the angular aperture of the window 210 about the longitudinal axis X. The outer doors 105 are arranged outside relative to the inner doors 104. Each outer door 105 is mounted facing an inner door 104 and the outer door 105 and the facing inner door 104 constitute a pair of doors. The thrust-reversing system 250 thus comprises a plurality of pairs of doors 104, 105 arranged inside the nacelle 102.

Each outer door 105 is mounted articulated on the runner 214 between a stowed position (FIGS. 3 and 4) and a deployed position (FIG. 5) and vice versa. The switch from the stowed position to the deployed position is performed by a rotation of the outer door 105 towards the outside of the turbojet engine 100. The articulations of the outer doors 105 are globally facing the articulations of the inner doors 104 as is shown in FIG. 5, when the inner doors 104 and the outer doors 105 are deployed, they globally form a continuity.

The stowed position of the outer doors 105 can be adopted when the frame 207b is in advanced position or in retracted position. The deployed position can be adopted only when the frame 207b is in retracted position. The deployed, respectively stowed, position of the outer doors 105 is synchronized with the deployed, respectively stowed, position of the inner doors 104.

In stowed position, each outer door 105 blocks a zone of the openwork part of the frame 207b when the latter is in advanced position and the same zone of the openwork part of the frame 207b and a zone of the window 210 when the frame 207b is in retracted position. In deployed position, the outer door 105 does not block the zone of the window 210 or the openwork part of the frame 207b and extends towards the outside of the nacelle 102 allowing the passage of the secondary flow 208.

Thus, in stowed and advanced position, each outer door 105 is globally in the extension of the mobile cowl 207a on the outside of the fan casing 206a and in deployed position, each outer door 105 opens outwards and deflects the part of the secondary flow 208 which has previously been deflected by the inner doors 104 through the window 210.

In stowed position, the outer doors 105 are arranged between the mobile cowl 207a and the fixed structure 206 so as to constitute an outer wall of the nacelle 102 which is therefore in contact with the air flow which flows around the nacelle 102.

Each outer door 105 is articulated by a rear edge on the runner 214 on hinges 213 fixed to the runner 214 while the opposite front edge is free and is positioned towards the front in stowed position and towards the outside in deployed position.

For each pair of doors 104, 105, the thrust-reversing system 250 therefore presents a runner 214 associated with the pair of doors 104, 105. The runner 214 is mounted to be translationally mobile according to a direction parallel to the direction of translation on the frame 207b. The runner 214 is thus mobile between a first position which corresponds to the stowed position and a second position which corresponds to the deployed position. Each door 104, 105 is thus articulated on the runner 214 and is therefore independent of the mobile cowl 207 and it is not fixed thereto.

The switch from the first position to the second position of the runner 214 is mechanically associated with the switch from the stowed position to the deployed position of each door 104, 105 and vice versa.

In the particular embodiment presented here, the thrust-reversing system 250 also has, for each runner 214, a first transmission system 216 which is provided to switch the inner door 104 associated with the runner 214, from the stowed position to the deployed position simultaneously with the switching of the runner 214 from the first position to the second position in order to open the inner door 104 and vice versa.

Likewise, the thrust-reversing system 250 also has, for the runner 214, a second transmission system 217 which is provided to switch the outer door 105 associated with the runner 214 from the stowed position to the deployed position simultaneously with the switching of the runner 214 from the first position to the second position in order to open the outer door 105 and vice versa.

In the embodiment of the disclosure herein presented here, to reach the first position, the runner 214 is displaced towards the rear whereas, to reach the second position, the runner 214 is displaced towards the front.

The translation of the runner 214 on the frame 207b is produced by any appropriate guideway system such as, for example, that which is described herein below.

The switch from the advanced position of the frame 207b to the retracted position of the frame 207b and deployed position of the inner doors 104 and of the outer doors 105 therefore consists in or comprises, from the advanced position of the frame 207b and therefore from the stowed positions of the inner 104 and outer 105 doors, retracting the frame 207b by translation relative to the front frame 206 to reach the retracted position for the frame 207b and the stowed positions of the inner 104 and outer 105 doors, then in displacing each runner 214 from the first position to the second position, that is to say towards the front, to switch the inner doors 104 and the outer doors 105 from the stowed position to the deployed position.

The reverse displacement makes it possible to revert to the advanced position.

The nacelle 102 also comprises a set of actuators 218 and 220 ensuring the translational displacement of the frame 207b and of the runner 214. Each actuator 218, 220 is controlled by a control unit, for example of processor type, which controls the displacements in one direction or in the other depending on the needs of the aircraft 10.

Each actuator 218, 220 can for example take the form of an electric ball screw jack or any other appropriate type of screw jack.

To ensure the displacement of the frame 207b, the nacelle 102 comprises at least one first actuator 218 fixed for one part to the fixed structure 206 of the nacelle 102 and for one part to the frame 207b. Each first actuator 218 is thus provided to ensure, from the advanced position of the frame 207b and therefore the stowed positions of the 104 and outer 105 doors, a translational displacement of the frame 207b to the retracted position, and vice versa. In the displacement of the frame 207b, each runner 214 which is borne by the frame 207b follows the same displacement.

Here, the cylinder of the first actuator 218 is fixed to the fixed structure 206 and the mobile rod of the first actuator 218 is fixed to the frame 207b.

To ensure the displacement of each runner 214, and therefore of each inner 104 and outer 105 door, the thrust-reversing system 250 comprises, for each runner 214, a second actuator 220 which is fixed for one part to the frame 207b and for one part to the runner 214. The second actuator 220 is provided to ensure the translational displacement of the runner 214 from the first position to the second position.

Here, the cylinder of the second actuator 220 is fixed to the frame 207b and the mobile rod of the second actuator 220 is fixed to the runner 214.

The second actuator 220 is distinct from each first actuator 218 and they can therefore be displaced independently of one another. The displacement of the mobile assembly 207 from the advanced position to the retracted position is dissociated from the displacement of the doors 104 and 105.

FIG. 6 shows an outer view of the nacelle 102 which shows the guideway system between the frame 207b and the runner 214.

To produce the guideway system, the frame 207b comprises two rods 602 arranged across the window 210 and extending parallel to the direction of translation. For each rod 602, 604, the runner 214 has a bore in which the rod 602, 604 is fitted, which allows the runner 214 to be displaced along the rods 602 and 604.

The first transmission system 216 comprises at least one first connecting rod articulated by one end on the inner door 104 and articulated by another end on the mobile assembly 207 and more particularly on a part of the frame 207b arranged forward relative to the articulation of the first connecting rod on the inner door 104.

For reasons of balance, the first transmission system 216 comprises two first connecting rods arranged on either side of a median plane of the inner door 104 and passing through the longitudinal axis X.

The second transmission system 217 comprises at least one second connecting rod articulated by one end on the outer door 105 and articulated by another end on the mobile assembly 207 and more particularly on a part of the frame 207b arranged in front relative to the articulation of the second connecting rod on the outer door 105.

Likewise, for reasons of balance, the second transmission system 217 comprises two second connecting rods arranged on either side of a median plane of the outer door 105 and passing through the longitudinal axis X as is represented in FIG. 6.

The disclosure herein has been more particularly described in the case of a nacelle under a wing but it can be applied to a nacelle situated at the rear of the fuselage.

To improve the control of the secondary flow 208 even further, the nacelle 102 comprises at least one baffle 226 (if there are several thereof, it is then a cascaded gate) which is arranged around the secondary jet 202 at the inlet of the window 210, that is to say globally at the zone of passage from the secondary jet 202 to the window 210 in a zone where the flow has the greatest difficulty in turning to create the reverse thrust (that is to say towards the front of the nacelle).

Each baffle 226 is fixed to the mobile assembly 207 of the nacelle 102. Each baffle 226 takes the form of an aileron which orients the secondary flow 208 towards the window 210 then towards the front of the dual-flow turbojet engine 100. In the embodiment of the disclosure herein presented here, in position of closure, each baffle 226 is housed in the fixed structure 206 between the outer door 105 and the inner door 104.

In the embodiment of the disclosure herein presented in FIG. 6, the baffles 226 are arranged between the rods 602 and 604.

While at least one exemplary embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A dual-flow turbojet engine comprising an engine, a nacelle surrounding the engine and a fan casing, in which a secondary jet of a secondary flow is between the nacelle and the engine and in which an air flow can circulate according to a direction of flow, the nacelle comprising:
a fixed structure attached to the fan casing;
a thrust-reversing system comprising:
a mobile assembly having a frame and a mobile cowl fixed to the frame, the mobile assembly being translationally mobile on the fixed structure according to a direction of translation between an advanced position in which the mobile assembly is positioned such that the mobile cowl is close to the fan casing and a retracted position in which the mobile assembly is positioned such that the mobile cowl is away from the fan casing to define, between them, an open window between the secondary jet and an outside of the nacelle;
a plurality of pairs of doors, each pair being formed by an inner door and an outer door arranged facing the inner door;
for each pair of doors, a runner mounted to be translationally mobile parallel to the direction of translation on the frame between a first position and a second position;
wherein each door of a pair is mounted articulated by a rear edge on the associated runner between a stowed position in which it blocks a zone of the window and a deployed position in which it does not block the zone of the window, the inner doors extending towards the engine in deployed position, the outer doors extending towards the outside of the nacelle in deployed position;
for each runner, a first transmission system to switch the inner door associated with the runner from the stowed position to the deployed position simultaneously with the switching of the runner from the first position to the second position and vice versa, and a second transmission system to switch the outer door associated with the runner from the stowed position to the deployed position simultaneously with the switching of the runner from the first position to the second position and vice versa, and
at least one first actuator provided to ensure translational displacement of the frame from the advanced position to the retracted position and vice versa, and
for each runner, a second actuator fixed partly to the frame and configured to ensure translational displacement of the runner from the first position to the second position and vice versa.

2. The dual-flow turbojet engine according to claim 1, wherein the frame comprises two rods arranged across the window and extending parallel to the direction of translation, and wherein, for each rod, the runner has a bore in which the rod is fitted.

3. The dual-flow turbojet engine according to claim 1, wherein the first transmission system comprises at least one first connecting rod articulated by one end on the inner door and articulated by another end on the frame.

4. The dual-flow turbojet engine according to claim 3, wherein the first transmission system comprises two first connecting rods on either side of a median plane of the inner door.

5. The dual-flow turbojet engine according to claim 3, wherein articulation on the frame is arranged forward relative to articulation of the first connecting rod on the inner door.

6. The dual-flow turbojet engine according to claim 1, wherein the second transmission system comprises at least one second connecting rod articulated by one end on the outer door and articulated by another end on the frame.

7. The dual-flow turbojet engine according to claim 6, wherein the second transmission system comprises two second connecting rods on either side of a median plane of the outer door.

8. The dual-flow turbojet engine according to claim 6, wherein articulation on the frame is forward relative to articulation of the second connecting rod on the outer door.

9. The dual-flow turbojet engine according to claim 1, wherein the outer doors are between the mobile cowl and the fixed structure in a stowed position so as to constitute an outer wall of the nacelle.

10. An aircraft comprising at least one dual-flow turbojet engine comprising a nacelle surrounding the engine and a fan casing, in which a secondary jet of a secondary flow is between the nacelle and the engine and in which an air flow can circulate according to a direction of flow, the nacelle comprising:
a fixed structure attached to the fan casing;
a thrust-reversing system comprising:
a mobile assembly having a frame and a mobile cowl fixed to the frame, the mobile assembly being translationally mobile on the fixed structure according to a direction of translation between an advanced position in which the mobile assembly is positioned such that the mobile cowl is close to the fan casing and a retracted position in which the mobile assembly is positioned such that the mobile cowl is away from the fan casing to define, between them, an open window between the secondary jet and an outside of the nacelle;
a plurality of pairs of doors, each pair being formed by an inner door and an outer door arranged facing the inner door;
for each pair of doors, a runner mounted to be translationally mobile parallel to the direction of translation on the frame between a first position and a second position;
wherein each door of a pair is mounted articulated by a rear edge on the associated runner between a stowed position in which it blocks a zone of the window and a deployed position in which it does not block the zone of the window, the inner doors extending towards the engine in deployed position, the outer doors extending towards the outside of the nacelle in deployed position;
for each runner, a first transmission system to switch the inner door associated with the runner from the stowed position to the deployed position simultaneously with the switching of the runner from the first position to the second position and vice versa, and a second transmission system to switch the outer door associated with the runner from the stowed position to the deployed position simultaneously with the switching of the runner from the first position to the second position and vice versa, and
at least one first actuator provided to ensure translational displacement of the frame from the advanced position to the retracted position and vice versa, and
for each runner, a second actuator fixed partly to the frame and configured to ensure translational displacement of the runner from the first position to the second position and vice versa.
